(19) United States
(12) Patent Application Publication
(10) Pub. No.: US 2011/0143728 A1
(43) Pub. Date: Jun. 16, 2011

(54) METHOD AND APPARATUS FOR RECOGNIZING ACQUIRED MEDIA FOR MATCHING AGAINST A TARGET EXPRESSION

(75) Inventors: Jussi HOLOPAINEN, Tampere (FI); Jayoun Lee, Helsinki (FI); Elina Ollila, Kirkkonummi (FI); Juha Arrasvuori, Tampere (FI); Marion Boberg, Suinula (FI)

(73) Assignee: Nokia Corporation, Espoo (FI)

(21) Appl. No.: 12/639,635

(22) Filed: Dec. 16, 2009

(51) Int. Cl. H04M 3/42

(52) U.S. Cl. 455/414.1

(57) ABSTRACT

An approach is provided for acquiring media corresponding to a target expression. The expression platform receives a request specifying one or more target expressions. Next, the expression platform causes, at least in part, acquisition of media including an expression of one or more emotions. Next, the expression platform performs recognition analysis on the media to extract expression data. Next, the expression platform matches the extracted expression data against reference data corresponding to the one or more target expressions. Then, the expression platform computes a similarity score between the extracted expression data and the matched target expression.

### BACKGROUND

Service providers (e.g., wireless, cellular, etc.) and device manufacturers are continually challenged to deliver value and convenience to consumers by, for example, providing compelling network services. One area of development has been the use of technology for facial and other forms of automated recognition (e.g., recognition expressions such as facial expressions, body gestures, movement, voice, sound etc.). For example, many modern communication devices (e.g., smartphones, handsets, etc.) are commonly equipped with cameras and other sensors (e.g., microphones) that enable the devices to perform such recognition (e.g., facial, voice, and/or expression recognition). However, it is noted that recognition technology has been underused and has not been fully exploited, particularly in mobile devices. For example, uses of recognition technology generally have been limited to user authentication or identification. Accordingly, service providers and device manufactures face significant technical challenges in applying recognition technology for innovative applications such as entertainment, gaming, socializing, and social networking.

### SOME EXAMPLE EMBODIMENTS

Therefore, there is a need for an approach for recognizing acquired media for matching against a specified target expression.

According to one embodiment, a method comprises receiving a request specifying one or more target expressions. The method also comprises causing, at least in part, acquisition of media including an expression of one or more emotions. The method further comprises performing recognition analysis on the media to extract expression data. The method further comprises matching the extracted expression data against reference data corresponding to the one or more target expressions. The method further comprises computing a similarity score between the extracted expression data and the matched target expression.

According to another embodiment, an apparatus comprising at least one processor, and at least one memory including computer program code, the at least one memory and the computer program code configured to, with the at least one processor, cause, at least in part, the apparatus to receive a request specifying one or more target expressions. The apparatus is also caused to acquire media including an expression of one or more emotions. The apparatus is further caused to perform recognition analysis on the media to extract expression data. The apparatus is further caused to match the extracted expression data against reference data corresponding to one or more target expressions. The apparatus is further caused to compute a similarity score between the extracted expression data and the matched target expression.

According to another embodiment, a computer-readable storage medium carrying one or more sequences of one or more instructions which, when executed by one or more processors, cause, at least in part, an apparatus to receive a request specifying one or more target expressions. The apparatus is also caused to acquire media including an expression of one or more emotions. The apparatus is further caused to perform recognition analysis on the media to extract expression data. The apparatus is further caused to match the extracted expression data against reference data corresponding to one or more target expressions. The apparatus is further caused to compute a similarity score between the extracted expression data and the matched target expression.

According to another embodiment, an apparatus comprises means for receiving a request specifying one or more target expressions. The apparatus also comprises means for causing, at least in part, acquisition of media including an expression of one or more emotions. The apparatus further comprises means for performing recognition analysis on the media to extract expression data. The apparatus further comprises matching the extracted expression data against reference data corresponding to the one or more target expressions. The apparatus further comprises computing a similarity score between the extracted expression data and the matched target expression.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of recognizing acquired media for matching against a target expression, according to one embodiment;

FIG. 2 is a diagram of the components of the expression platform, according to one embodiment;

FIG. 3 is a flowchart of a process for recognizing acquired media for matching against a target expression, according to one embodiment;

FIG. 4 is a flowchart of a process for sharing acquired media, according to one embodiment;

FIG. 5 is a flowchart of a process for acquiring additional media to verify a matched target expression, according to one embodiment;

FIG. 6 is a flowchart of a process for comparing context information associated with acquiring media for recognition, according to one embodiment;

FIG. 7 is a diagram of a user interface utilized in the processes of FIG. 3, according to one embodiment;

FIGS. 8A-8C are diagrams of user interfaces utilized in the processes of FIG. 3, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for acquiring media corresponding to a target expression are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

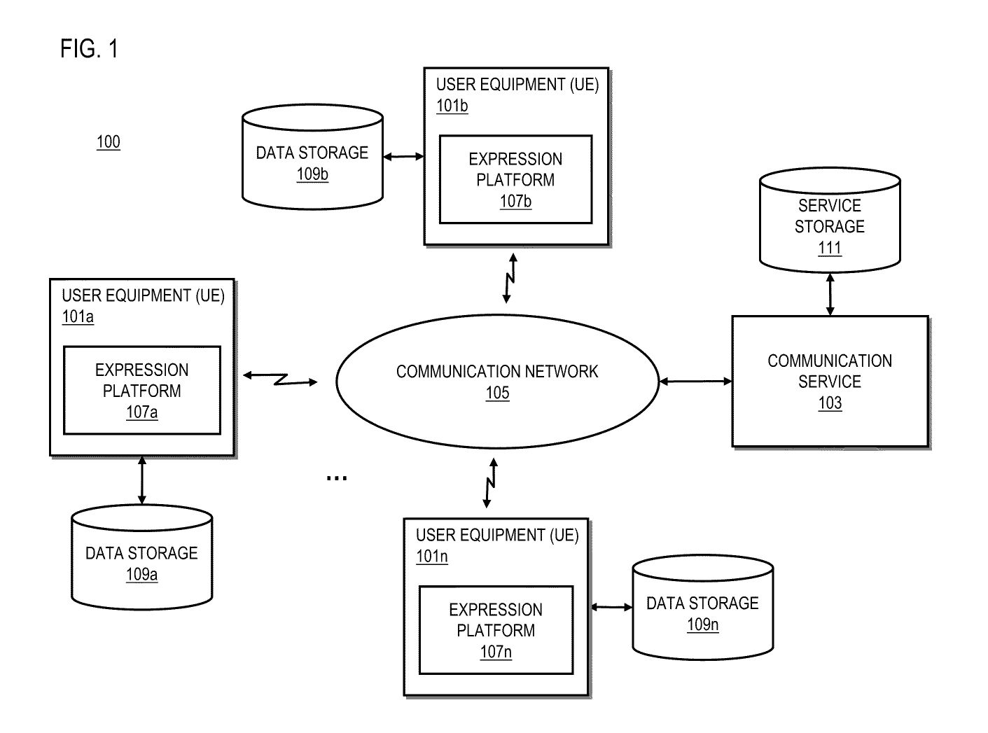

FIG. 1 is a diagram of a system capable of recognizing an acquired image for matching against a target expression, according to one embodiment. It is noted that recognition methods such as facial or voice recognition have been under development over the years. As a result of this development, recognition methods have become even more sophisticated and accurate. Additionally, facial recognition methods have been extended to recognize facial expressions by analyzing, for instance, notable features in a face such as eyes, a nose and a mouth, and relative distances to key facial features. Further, voice and sound recognition methods have been extended from recognizing speech to recognizing vocal expressions such as laughter and crying as well as general ambient or background noises (e.g., traffic, sounds from a party, etc.). However, as noted previously, these advances in expression recognition capabilities have not resulted in a commensurate growth of new or innovative uses of such technology. In particular, recognition methods have not traditionally or commonly been used in areas such as gaming, social networking, socializing, and the like. Therefore, new methods to use the recognition methods in these areas need to be exploited.

By way of example, there are typically seven emotions that can be shown through facial expressions: fear, anger, surprise, contempt, disgust, happiness, and sadness. It is further noted that these emotions are generally the same for all people regardless of cultures, making such emotions universal and common experiences. For these reasons, recognition of expressions of these emotions (e.g., through facial, voice, and/or body expressions) may play a very useful role in various aspects of social networking, socializing, gaming, and other activities with potential social interactions. Recently, features have been implemented in a digital camera to recognize a smiling face. Further, features have been implemented such that a camera will allow capturing of an image of person only if a subject is smiling. However, recognition of expressions has not been conventionally used for social or gaming purposes. Because recognition of expressions may play an important role connecting people and may also serve other entertainment purposes, this is an area that needs active development for the maximized use of the recognition methods and the available technology. With the development of mobile devices including image-capturing capabilities as well as voice recording capabilities, it is desired to fully utilize recognition of faces, voice and any other expressions to enhance the user experience connected with the mobile devices.

To meet this need, a system 100 of FIG. 1 introduces the following capabilities: (1) specifying target expressions, (2) acquiring media and matching the acquired media against reference data corresponding to the target expressions, and (3) computing a similarity score between the acquired media and the matched target expression. More specifically, the system 100 requests a user to acquire media of specified target expressions, and performs a recognition analysis to match the acquired media and one or more target expressions. When one or more target expressions are specified, the target expressions are the expressions that a user aims to capture by acquiring media including the target expressions. The target expressions may be facial expressions or body expressions (e.g., body gestures) or may also include sounds such as laughter or moaning Further, it is contemplated that the captured media may be an expression by a person, but may also be an expression by an animal, or a collection of objects or a structure that resembles human's expression. When the acquired media is matched with one of the target expressions, a similarity score representing a degree of similarity between the acquired media and the target expression is computed.

In one embodiment, additional media such as multiple images or a video clip may be captured around the time of acquisition of the media, in order to provide additional information on the acquired media such that enhanced matching may be performed between the acquired media and the target expressions. For example, expression data extracted from the additional media may be used to verify the match performed using just the acquired data and the target expressions.

Further, in certain embodiments, the system 100 specifies target expressions as challenge or game in which the user collects media of the target expressions to score points. When media is acquired to match with all of the specified target expressions, the system 100 provides the option for the user to share the media acquired for the target expressions with other devices (e.g., UEs 101a-101n). The media may also be shared with a communication service 103 or any Internet-based website such as social networking websites.

As used herein, the term “media” refers to various forms of media, including audio, video, still images, pictures, etc. Further, as used herein, the term “image” refers to one or a series of images taken by a camera (e.g., a still camera, digital camera, video camera, camera phone, etc.) or any other imaging equipment. By way of example, a single image may represent a photograph and multiple images may be combined in sequence to make a video clip.

As shown in FIG. 1, the system 100 comprises user equipment (UEs) 101a-101n capable of recognizing an acquired image for matching against a target expression. Thus, each of the UEs 101a-101n includes a component to acquire media (e.g., an image, a sound recording, etc.), such as a digital camera/camcorder, a scanning device, a sound recording device, or any other sensors that may be used to capture media data. The UEs 101a-101n also have connectivity to one another as well as to the communication service 103 via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), audio/video player, digital camera/camcorder, positioning device, television receiver, radio broadcast receiver, electronic book device, game device, or any combination thereof. It is also contemplated that the UE 101 can support any type of interface to the user (such as “wearable” circuitry, etc.). The UE 101 also includes or is connected to a data storage medium 109 to store and access imaging and/or recognition data.

The UE 101 may include an expression platform 107. The expression platform 107 is capable of handling acquisition of various types of media. The expression platform 107 communicates with a media capturing device in the UE 101 to acquire media and store the acquired media data in available storage media, such as the data storage medium 109. In order to acquire media, the expression platform 107 may show various options that a user can choose for acquiring media, and may provide a graphical user interface or icons to aid media acquisition. Further, the expression platform 107 may control displaying of acquired media or media to capture. The expression platform 107 also handles various computations related with acquired media data. For example, the expression platform 107 may match the acquired media data with target expressions or emotions, and compute a similarity score between the acquired media and the matched target expression. An advantage of computing a similarity score is that such a score can normalize metrics for comparing the closeness of acquired expression data to the one or more target expressions. Therefore, means for acquiring media, matching the acquired media against the target expressions, and computing the similarity score between the acquired media and the matched target expression are anticipated, e.g., using the expression platform 107.

Further, the expression platform 107 is capable of handling various communication operations using any form of communications available at the UE 101. For example, the expression platform 107 may manage incoming or outgoing communications via the UE 101, and display such communications as they are received or processed. In certain embodiments, the expression platform 107 may also provide visualization (e.g. graphical user interface) to allow a user to control communications over the communication network 105 using any available form of communications or to share media. For example, the expression platform 107 may include an option to select communications with the UEs 101a-101n in order to share media. Further, the expression platform 107 may include interfaces that allow the user to communicate with any Internet-based websites or to use e-mail services via the communication service 103. In addition, the expression platform 107 may also include interfaces to interact with social networking services, and allow uploading or sharing media from the UE 101 to the social networking services. The expression platform 107 may communicate with the data storage medium 109 to access or store media data or any other forms of data.

The communication service 103 provides various services related to communication to the UEs 101a-101n, such that the UEs 101a-101n can communicate with each other over the communication network. The services provided by the communication service 103 may include a cellular phone service, internet service, data transfer service, etc. The communication service 103 may also provide content such as music, videos, television services, etc. The communication service 103 may be connected to a service storage medium 111 to store or access data. The communication service 103 is also able to perform various computations, some of which may be performed for the UE 101. For example, the UE 101 may send media data to the communication service 103 in order to perform similarity computations between different media data, and the communication service 103 send the result of the computations back to the UE 101.

By way of example, the UE 101, and the communication service 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

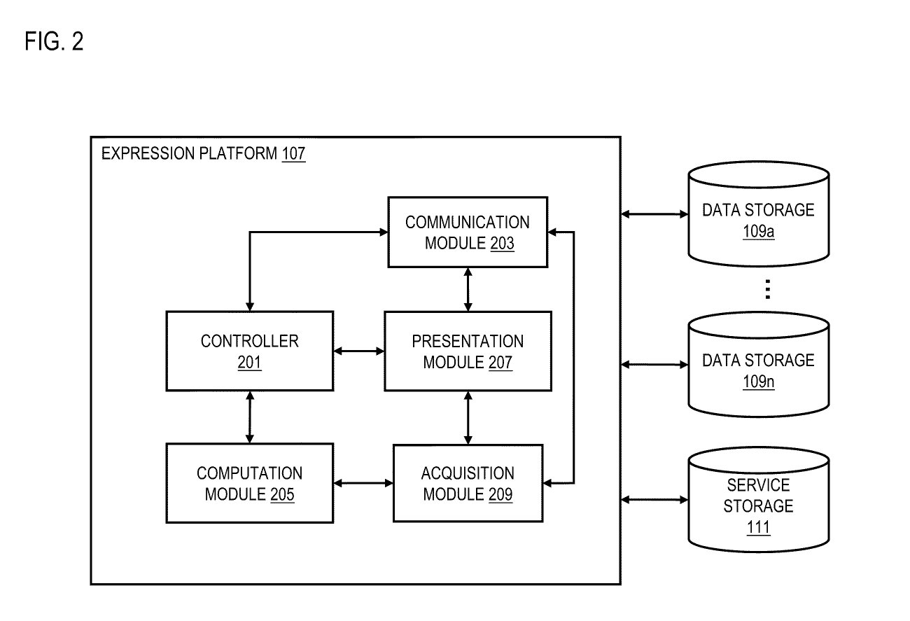

FIG. 2 is a diagram of the components of the expression platform 107, according to one embodiment. By way of example, the expression platform 107 includes one or more components for recognizing an acquired media for matching against a target expression. It is contemplated that the functions of these components may be combined in one or more components or performed by other components of equivalent functionality. In this embodiment, the expression platform 107 includes a controller 201, a communication module 203, a computation module 205, a presentation module 207, and an acquisition module 209. The controller 201 oversees tasks, including tasks performed by the communication module 203, the computation module 205, the presentation module 207 and the acquisition module 209. The communication module 203 manages and controls any incoming and outgoing communication such as media data sharing, receiving various requests from other UEs 101 or the communication service 103 as well as telephone calls, text messaging, instant messaging and Internet communications. The UE 101 may also be connected to storage media such as the data storage media 109a-109n such that the expression platform 107 can access or store communication history data. By way of example, if the data storage media 109a-109n are not local, then they may be accessed via the communication network 105. The UE 101 may also be connected to the service storage 111 via the communication network 105 such that the expression platform 107 may be able to manage or access media data or any other related data in the service storage medium 111. For example, the expression platform 107 can have the service storage medium 111 store media data or results from the matching of acquired media with target expressions from the UE 101. The computation module 205 performs various computations based on the acquired media, including matching the acquired media with the target expressions and computing similarity scores between the acquired media and the matched target expressions. The presentation module 207 controls display of a user interface such as graphical user interface, to convey information and to allow user to interact with the UE 101 via the interface. Further, the presentation module 207 interacts with the controller 201, the communication module 203 and the acquisition module 209 to display any information generated during their operation (e.g., displaying acquired images, target expression images, similarity scores between the acquired images and the target expression images, and any other information about the images). The acquisition module 209 communicates with a media capturing device in the UE 101 such as a digital camera/camcorder/sound recorder, in order to acquire media data and store them in the data storage 109.

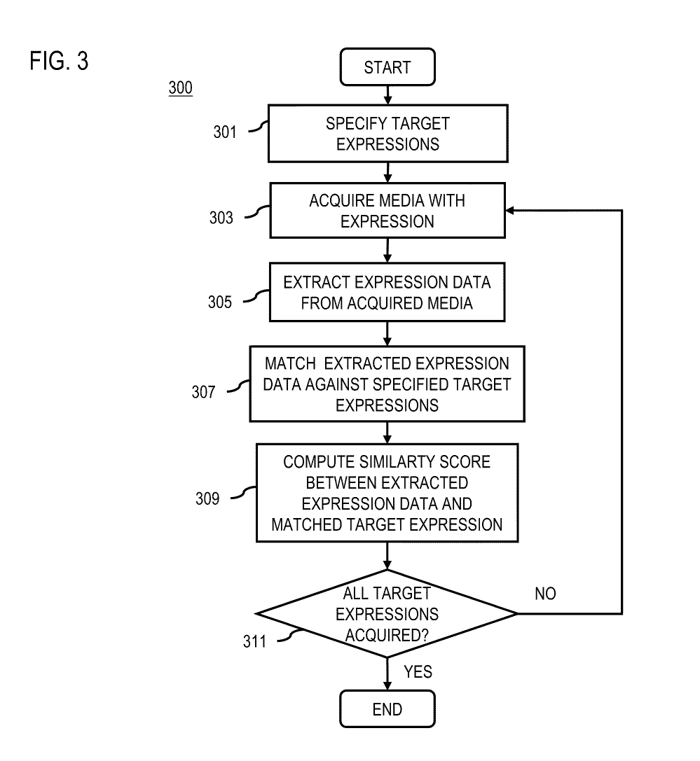

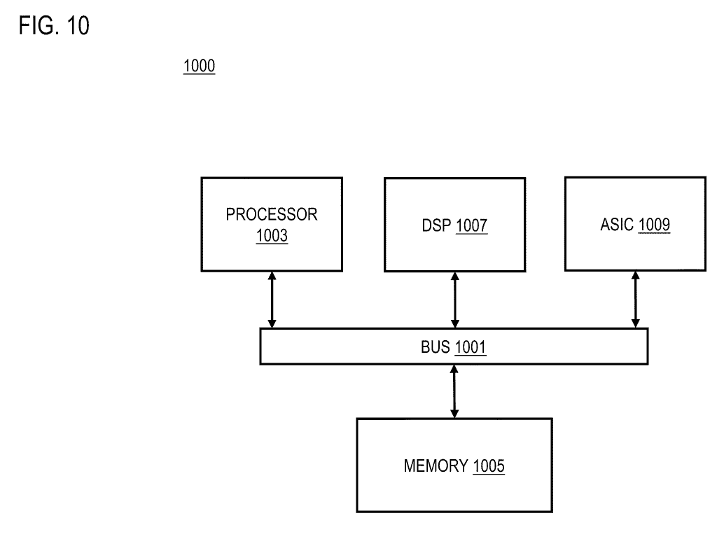

FIG. 3 is a flowchart of a process for recognizing an acquired media for matching against a target expression, according to one embodiment. In one embodiment, the expression platform 107 performs the process 300 and is implemented in, for instance, a chip set including a processor and a memory as shown FIG. 10. In step 301, one or more target expressions are specified. By way of example, the expressions may be specified by the service provider, the user, social networking contacts, other users, and the like. In this way, the expression platform 107 advantageously provides multiple sources for obtaining target expressions, thereby increasingly the likelihood that a potential user would be interested in undertaking the request or challenge to acquire expression data for matching against the target expressions. Therefore, a means for specifying a one or more target expressions and a means for receiving a request specifying one or more target expressions are anticipated, e.g., using the expression platform 107. Reference data corresponding to the target expressions may be pre-loaded in the UE 101 or may be downloaded from the communication service 103 or other UE 101. Alternatively, the reference data corresponding to the target expressions may be obtained and updated by crowdsourcing the data about expressions. As an example of the crowdsourcing, various users of the UEs 101 on the communication network 105 can continue to update the reference data to generate the reference data that provide the best result for matching the acquired media with the target expressions. The target expressions may be specified by a user using the UE 101, or as a request or challenge from another user using another UE 101 to acquire media corresponding to target expressions. Further, the target expression may also be specified automatically by the UE 101 or the communication service 103, when a certain conditions are satisfied (e.g. no media data has been acquired for a predetermined period of time). In addition, although not shown in the process in FIG. 3, a time limit may be imposed when the target expressions are specified. Then, media corresponding to the target expressions needs to be acquired within the time limit. This feature can be used as a challenge sent to a user of the UE 101.

The specified target expressions may be a single target expression or a set of target expressions belonging to the same category of expressions or a set of random target expressions. For example, the specified target expressions may include a target expression of a smiling face with opened eyes. As another example, the specified target expression may include a set of smiling faces as a category, wherein the set includes different smiling faces such as opened eyes, closed eyes, grinning and opened mouth. Because each of the target expressions includes data representing the specific target expression, the target expressions may include information on various facial expressions showing emotions such as fear, anger, surprise, contempt, disgust, happiness and sadness. Thus, the target expressions may include, for example, angry expressions, smiling expressions, sad expressions, etc. The target expressions may also include information on body expressions or gestures, such as holding up a first to express success or satisfaction. The target expression may be selected by a user from preset templates based on ghost expressions (e.g., generic representations of facial expressions such as a common “smiley face”). In certain embodiments, the user may customize the preset templates or other existing target expressions to create a new target expression. In yet another embodiment, the user may create a new target expression without starting from an existing template or expression. Furthermore, the target expressions may be made of photographs that are pre-stored in the data storage 109 or the service storage 111. In one example, the target expressions may be pictures downloaded from the user's social networking site, which may be sent to other users such that other users would have to acquire images that resemble the target expressions in a game format. In another example, a user of the UE 101a may also take a picture and send it to another user of the UE 101b as a target expression, as a way to challenge the user of the UE 101b to acquire a target expression designated by the user of the UE 101a. The target expressions may also be made from cartoon characters (e.g. Homer Simpson), or expressions that are designed by the user. In addition, media may be acquired from a subject that is not human. For example, an image may be acquired from an animal that may show a happy face. As another example, an image may be acquired from a painting as well as any structure or a set of objects that looks like the target expressions.

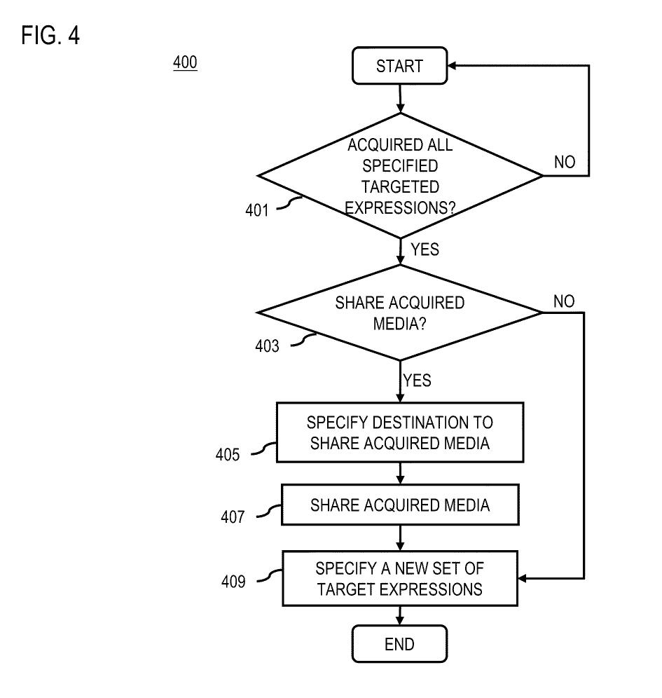

In step 303, media including an expression (e.g., a facial expression indicating one or more emotions) is acquired. The main purpose of acquiring the media is to acquire media that matches one of the target expressions. For example, the media may be acquired by a camera/camcorder device and/or sound recording device in the UE 101. However, the media may also be acquired by downloading media from Internet or from another UE 101 or any other available sources. In one example, images may be downloaded from the user's friends on a social networking service website, and be matched against the target expressions. Therefore, the means for acquiring the media with expression may be able to use various approaches in acquiring the media. In step 305, the expression platform 107 extracts expression data from the acquired media. The expression data may include any information that may be used to define expressions. Thus, for example, the expression data may include eye shapes (e.g. closed or opened), mouth shapes, eye brow shapes, location of a hand or other body parts, distances between facial features, etc. This is advantageous in that only information relevant for recognition is extracted, thereby reducing potential processing and resource burdens. Extracting data using, for instance, the expression platform 107 is a means to achieve this advantage. Next, in step 307, the expression platform 107 matches the extracted expression data against the reference data corresponding to the specified target expressions, so as to find a best match for the extracted expression data. In this case, a setting may be configured such that, if there is already an existing media matched with a target expression, and the newly acquired media is a better match for the target expression than the existing media, the newly acquired image may replace the existing media or display the newly acquired image instead of the existing media while keeping the existing media in a storage medium. In step 309, the expression platform 107 computes a similarity score between the extracted expression data and the matched target expression. The similarity score may be scaled such that a perfect score is 100 and the lowest score is 0. Further, a setting may be configured such that the media is rejected if the similarity score is below a predetermined minimum similarity score. Then, in step 311, the expression platform 107 checks whether all target expressions have been acquired. If all of the target expressions have not been acquired, then the process goes back to step 303 to acquire another media for the target expression that has not been acquired. The acquired media may be stored in the data storage 109 and/or the service storage 111 along with information regarding the matched target expressions, such that the media and their matched target expressions may be accessed at any time. By storing the acquired media (e.g., images or sound recordings) along with information about the matched target expressions, a user can build a large collection of media corresponding to various types of expressions. The acquired media may be manipulated. For example, an acquired image may be decorated with visual themes or other tools that can cut, paste, stretch or perform other tasks may be applied on the acquired image. This collection of media may also be used in various ways, such as sharing photos or defining status on social networking, etc. As one example, if media corresponding to all of the target expressions in a specified set (e.g. smiling faces) have been acquired, then the acquired media may be shared, as shown in the process in FIG. 4.

Additionally, although not shown in the process in FIG. 3, the target expressions may include multiple layers. For example, an initial layer of the target expression may be facial expression, the second layer of the target expression may be a body expression, and the third layer of the target expression may be a voice expression. Thus, for example, if images corresponding to smiling faces as target expressions have been acquired along with a giggling sound, the initial layer has been satisfied, and celebratory body expression is specified as the second layer of target expression such that a user will attempt to acquire an image with the celebratory body expression. Then, as a third layer, giggling or laughing sound may be set as a target expression such that an acquired media having a giggling sound would satisfy the third layer. When the user completes these three layers, all target expressions are acquired, and thus the task is completed. Alternatively, the different expressions may be used to adjust the similarity score between the acquired image and the target expression. For example, if the similarity score for an acquired image matched with a sad face may be adjusted to a lower score if the similarity score is very high and the body expression shows a happy expression with a first in the air.

Further, a reward may be given to the user after each successful completion of tasks (i.e. all target images acquired). The form of reward may be cash rewards, points, or an ability to unlock different features, etc. Another form of reward may be visual themes such as virtual clothes, accessories, plants, backgrounds, etc. that can be used to decorate the acquired media. In one embodiment, these visual themes may be used as gifts that can be sent to other users. When the visual themes are applied to the acquired media such as an image, the effects from the visual themes will show on the image when a user browses through the image. Another form of reward may also be ability to perform certain tasks or to block certain actions by other users (e.g. power-ups), such as forcing other users to receive gifts (e.g., as a gag or joke) or surprising other users with challenges to acquire images within a time limit or being able to refuse challenges or data transmissions from other users. In addition, if a user completes a certain task regarding acquiring images or exceeds a certain score in total sum of similarity scores, then a user's level may be increased. A user with a higher level may be given with better rewards or better gifts, which may be sent to other users. Further, the user that has reached a higher level may be provided with more power than a user with a lower level such that the user with a higher power may be able to exercise certain power over the user with a lower level, such as forcing transmission of a gift or images to the user with the lower level.

Furthermore, a special mode may be available such that an image with multiple subjects is acquired. For example, an image with facial expressions from multiple subjects may be acquired, and multiple expressions from these subjects may be matched in this image. In this feature, a combination of expressions may also be specified such that if an image having the combination of expression is acquired, the user is provided with a reward. For example, if the specified combination of expressions may be “smile and frown,” an acquired image with a subject with a smile and another subject with a frown will complete the task of acquiring the specified combination of expressions. Furthermore, the acquired image may be coupled with a pre-existing image. For example, a face with facial expression may be coupled with a cartoon character's body. As another embodiment of the special mode, if an acquired image with multiple subjects has a subject with a subversive expression that stands out from the rest of the subjects' expression, certain rewards or extra points may be provided. For example, if the acquired image shows five subjects showing a smiling face and one subject showing a frown, then rewards may be provided for capturing the subversive expression (i.e., frown).

FIG. 4 is a flowchart of a process for sharing acquired media, according to one embodiment. In one embodiment, the expression platform 107 performs the process 400 and is implemented in, for instance, a chip set including a processor and a memory as shown FIG. 10. If the expression platform 107 determines that media corresponding to all specified target expressions have been acquired, as shown in step 401, the expression platform 107 inquires whether to share the acquired media, as shown in step 403. This inquiry may be presented to a user of the UE 101 by displaying a prompt with the inquiry, for example. If it is determined that the acquired media will not be shared, a new set of target expressions may be specified to request acquiring more media, as shown in step 409. If it is determined that the acquired media will be shared, then a destination to share the acquired media is specified, as shown in step 405. The destination may include other UEs 101a-101n in the communication network. The destination may also include other users and their phone number, e-mail addresses or instant messenger screen name, so that the media may be sent via media messaging service, e-mail or instant messenger. A user setting may be configured to control sharing of the media. In one example, the UE 101 may be set such that the media with the best similarity scores will be shared or be allowed to be received by the UE 101. In this example, the best scored or highest rated media may be fed from the UE 101 used by the user to another device in real-time as the media is acquired. In another example, the UE 101 may be set such that media will be shared or be received (i.e. fed) by the UE 101 based on the specified user devices. In addition, a location-based services (LBS) mode may be used to receive (i.e. feed) only pictures that are taken near the UE 101, wherein the pictures may be received in real-time. Further, the media acquired by a user and matched with a target expression may be traded with another media acquired by another user and matched with another target expression. In addition, the users may rate the shared media depending on the users' opinion on the media's similarity to the target expression. This rating may be presented as a mini-game, wherein the users may try to guess the similarity score by rating the acquired media.

Further, the destination may include an Internet website such as social networking websites including Facebook, MySpace, Twitter, etc., so that the media may be posted on the website. This media may also be shared with other UEs 101 or on the social networking service websites, in a form of status. For example, if a user sets the status to be “happy,” an acquired image corresponding to “smile” target expression may be displayed on the status. In this example, as the collection of images corresponding to various expressions grows, there will be many available images that can be used to show the status. In addition, the media to be shared may also include confidential privacy information which allows only specific users to access the images. In this feature, settings may be configured such that other users need to conduct a special action, such as adding the user as a friend, in order to view the confidential images. Further, a user may be able to force other users to change their profiles with media acquired by the user. The media used to change other users' profiles may come from a collection of media acquired by the user. Additionally, the UE 101 may be configured such that the UE 101 would prevent a certain media or other forms of data from being sent to the UE 101. Once the destination is specified, acquired media is shared, as shown in step 407. Then, a new set of target expressions may be specified, as shown in step 409.

This process provides advantages in that this process facilitates socializing and social networking by sharing the acquired media. The expression platform 107 is a means for achieving these advantages.

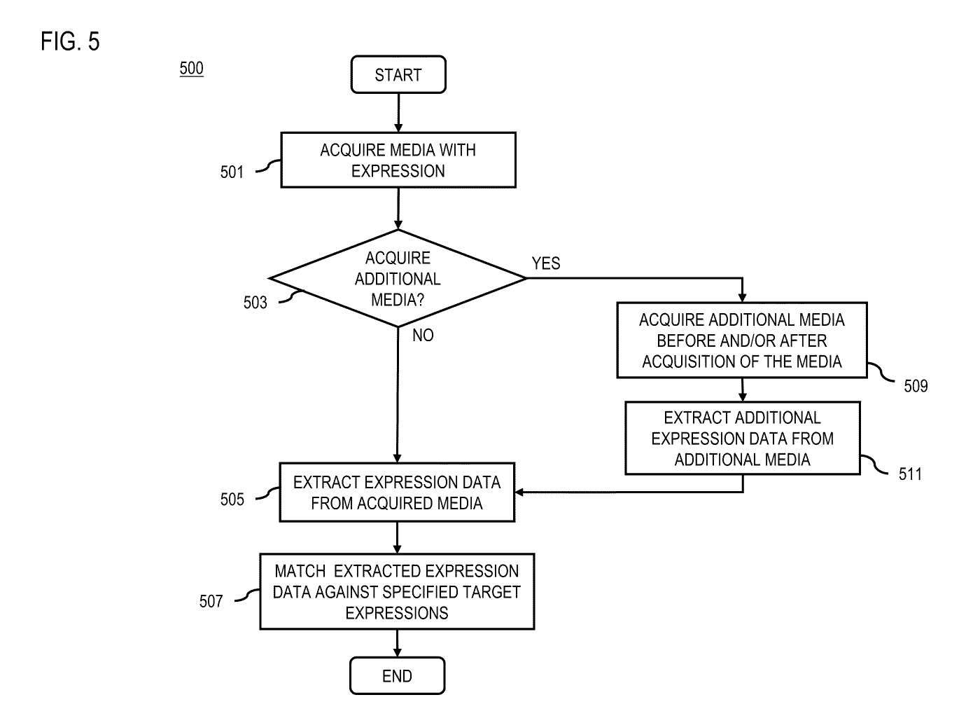

FIG. 5 is a flowchart of a process for acquiring additional media to verify a matched target expression, according to one embodiment. In one embodiment, the expression platform 107 performs the process 500 and is implemented in, for instance, a chip set including a processor and a memory as shown FIG. 10. When acquiring media with expression as shown in step 303 of FIG. 3, additional media may be acquired to enhance the matching of the target expressions. In step 501, media with expression is acquired. Then, it is determined whether additional media will be acquired, as shown in step 503. If additional media is not to be acquired, then the expression data is extracted from the acquired media, as shown in step 505, and then the extracted expression data is matched against the specified target expressions, as shown in step 507. On the contrary, if additional media are to be acquired, then additional media at a time before and/or after the time of acquisition of the media are acquired, as shown in step 509. The additional media may be taken as a set of plurality of images or as a video clip, or may be taken as a sound clip, for example. Additional expression data is then extracted from the additional media, as shown in step 511, and the expression data from the acquired media is extracted as shown in step 505. Thus, with the additional media, the expression data available include the expression data extracted from the acquired media and the additional expression data extracted from the additional media. Then, this available extracted expression data is matched against the specified target expression in step 507. For example, when the extracted expression data is matched, because there are multiple images available as additional media, the best match may be found between one of the images and the specified target expressions. When media with expression is acquired, the timing of acquisition may not always be the best timing for capturing the expression. Thus, one advantage of acquiring additional media taken at different time frames is to have various media data available such that at least one of the available images will be the best image to represent a specified target expression. Alternatively, the additional media may be used as additional data to provide information to adjust the similarity score. For example, if the acquired media shows an image with a smiling face and the additional media shows a video with a smiling face, then additional media is considered to support the acquired media. In another example, if the acquired media shows an image with a happy grin, but additional media has a sound recording of crying, then the additional media does not support the acquired media. Depending on whether the additional media supports the acquired data, the similarity score may be adjusted accordingly.

This process advantageously provides additional verification or confirmation of initial matching results. Capturing or acquiring additional media (e.g., images, videos, sound recordings, etc.) immediately before or after the acquisition of media for comparison against target expressions is a means to achieve this advantage.

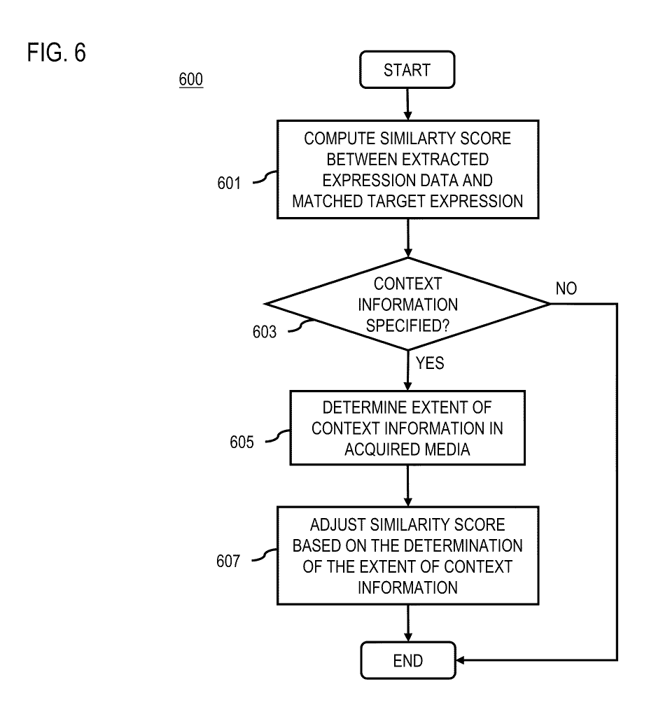

FIG. 6 is a flowchart of a process for comparing context information associated with acquiring media for recognition, according to one embodiment. In one embodiment, the expression platform 107 performs the process 600 and is implemented in, for instance, a chip set including a processor and a memory as shown FIG. 10. After a similarity score between the extracted expression data and the matched target expression is computed, as shown in step 601, the expression platform 107 determines whether context information is specified, as shown in step 603. The context information may be any background information surrounding a subject from which the expression data is extracted. Thus, the context information may specify a location, circumstances, specific occasions like parties or celebration, etc. If the context information is specified, then the extent of the context information in the acquired media is determined, as shown in 605. In order to determine the extent of the context information, any type of pattern matching or recognition technology may be used to determine how close the context in the acquired media is to the specified context information. Then, the similarity score may be adjusted based on the determination of the extent of context information, as shown in step 607. Thus, if the extent of context information in the acquired media is determined to be little, then the similarity score will be lowered. In one example of this process, the target expression is specified as “smile” and the context information may be specified as a beach such that the overall target expression is “a smile by the beach.” In this case, the similarity score computed between the acquired image and the target expression (e.g. smiling face) may be adjusted depending on whether the background of the acquired image is a beach or not. Further, objects in a background may be used to determine a context. For example, a target expression may be if an image captured has confetti or fireworks, this would mean a celebration or happy moments. Thus, if the target expression is specified as “smile,” the overall target expression may be specified as “a smile in celebration.”

Adding context information as part of the challenge of acquiring media to match against target expressions advantageously provides additional challenges to the user to generate more interest in participating. Therefore, determining and comparing context information in the acquired media is a means to achieve this advantage.

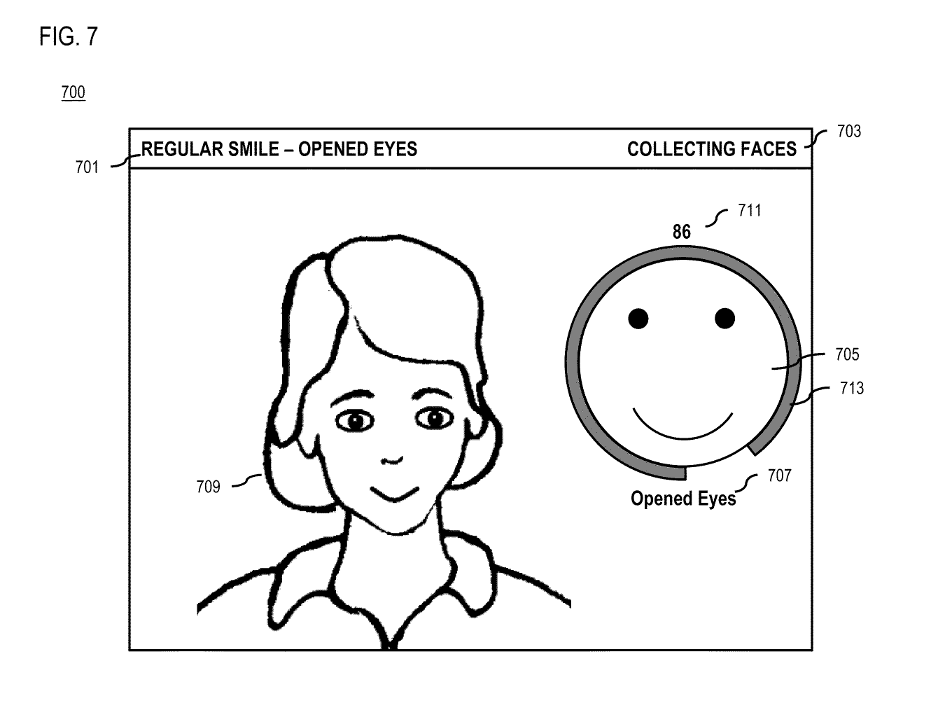

FIG. 7 is a diagram of a user interface utilized in the processes of FIG. 3, according to one embodiment. In this diagram, an image is used as an example of acquired media. User interface element 701 shows that a target expression “Opened Eyes” is under a category “Regular Smiles.” Each category of expression may include one or more target expressions. User interface element 703 shows that the mode the expression platform 107 is in “Collecting Faces.” User interface element 705 is a shape of a target expression that a user aims to collect by taking a picture, and user interface element 707 shows the name of the target expression, which is “Opened Eyes” in FIG. 7. When a picture 709 is taken, the picture 709 is displayed next to the target expression shown in 705, and the similarity score 711 between the target expression and the picture 709 is computed and displayed. The progress bar 713 may also appear to show a graphical representation of the similarity score 711. Further, the target expression 705 may be initially dimmed or in grayscale. Then, once an image that matches the target expression 705 is acquired, the target expression 705 may be highlighted in color.

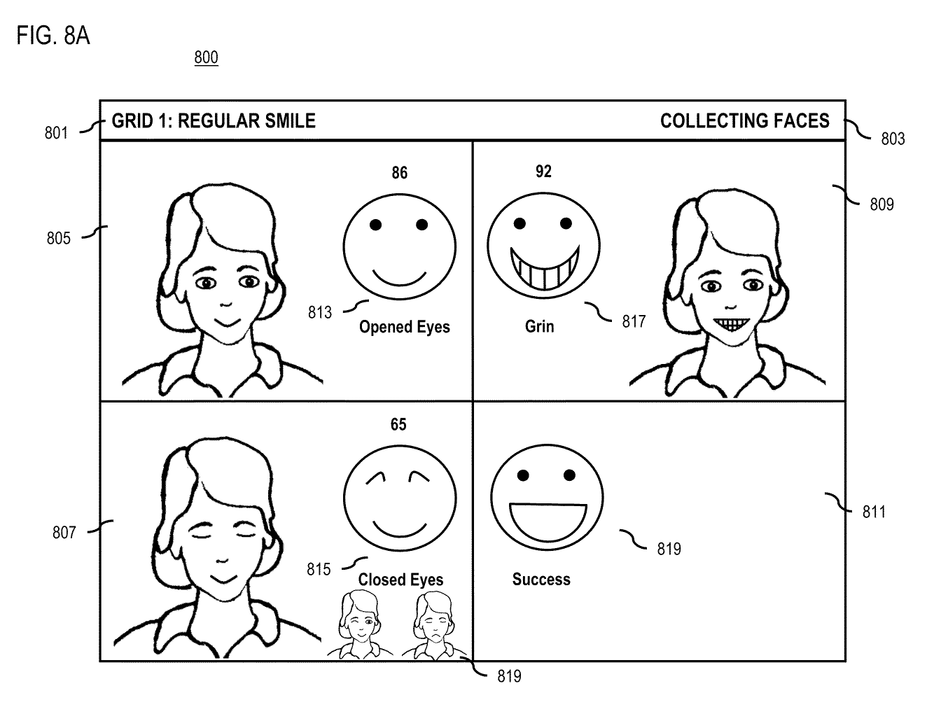

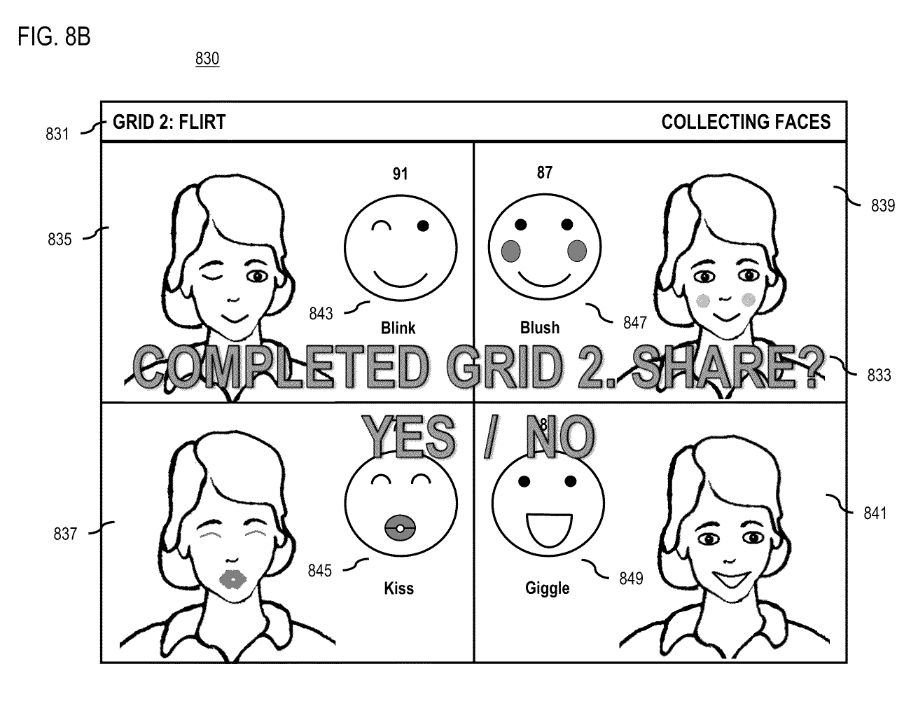

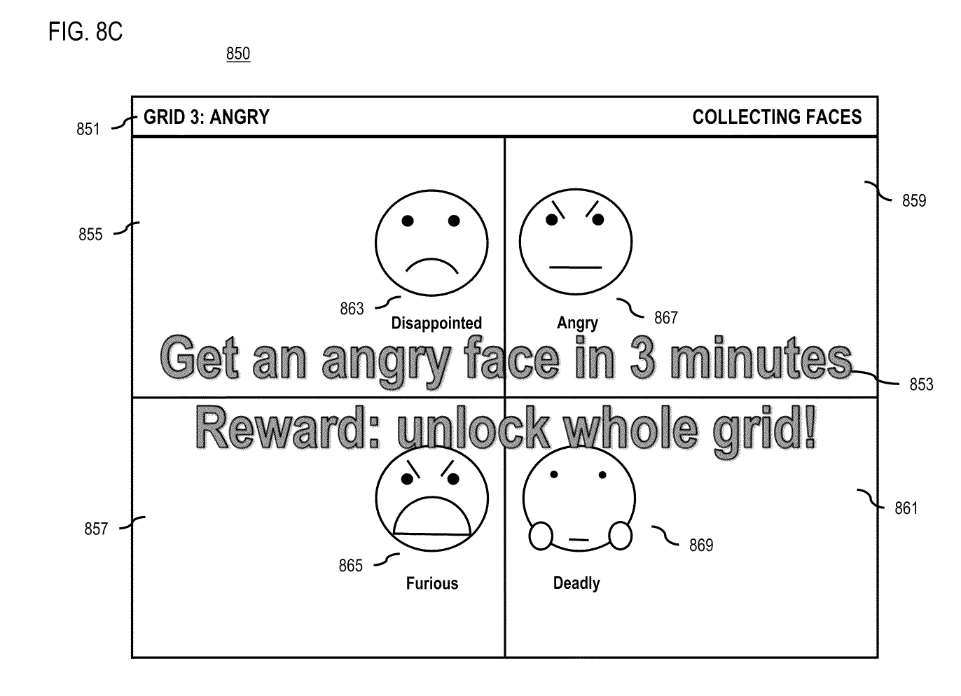

FIGS. 8A-8C are diagrams of user interfaces utilized in the processes of FIG. 3, according to various embodiments. In this diagram, an image is used as an example of acquired media. FIGS. 8A-8D show that there are four target expressions, which are allocated in four quadrants. In FIG. 8A, user interface element 801 shows that a category for the target expressions is “Regular Smiles.” User interface element 803 shows that the mode the expression platform 107 is in “Collecting Faces.” The four quadrants 805, 807, 809 and 811 show four target expressions, Opened Eyes 813, Closed Eyes 815, Grin 817 and Success 819, respectively. Each of the four quadrants 805, 807, 809 and 811 has similar features as the diagram shown in FIG. 7. When a user tries to fill “Grid 1: Regular Smiles” 801 with the target expressions Opened Eyes 813, Closed Eyes 815, Grin 817 and Success 819, the user takes a picture of an expression. The picture taken by the user is matched against the target expressions Opened Eyes 813, Closed Eyes 815, Grin 817 and Success 819, and is matched with the closest target expression. After the matching, the picture taken by the user is displayed in a corresponding quadrant with the matched target expression. In FIG. 8A the pictures are taken and matched for Opened Eyes 813, Closed Eyes 815 and Grin 817. However, no picture that matches Success 819 has been taken yet. Thus, Grid 1 is not yet complete. Further, additional images acquired and matched with Closed Eyes 815 are displayed in a smaller image, as shown in 819. The images in 819 may also be selected to display on the quadrant 807 along with a corresponding similarity score.

FIG. 8B shows another example with a different grid (i.e. Grid 2). In FIG. 8B, 831 shows that the category for the target expressions is “Flirt.” Under the category “Flirt,” four quadrants 835, 837, 839 and 841 showing four target expressions, Blink 843, Kiss 845, Blush 847 and Giggle 849. In FIG. 8B, pictures corresponding to every one of the four target expressions Blink 843, Kiss 845, Blush 847 and Giggle 849 have been collected, and thus Grid 2 is complete. When Grid 2 is completed, a prompt 833 is displayed to provide options to share the completed Grid 2 with other users. The options may include a list of users and their contact address (e.g. phone numbers, e-mail addresses, etc.) such that the users to share the completed grid can be selected from the list of the users. The options may also include links to social networking services such as Facebook or MySpace such that the completed grid can be sent to the social networking service and be posted on a user's page on the social networking service. Further, after images are acquired to complete the set of four target expressions (i.e., complete a grid), a new grid including a new set of target expressions may be presented. There may be a specific order of target expressions when presenting them as a new grid. Alternatively, the new grid may be presented in a random fashion. Even after the new grid is presented, a user still has an option to go back to the completed grid and acquire more images corresponding to the target expressions on the completed grid.

FIG. 8C shows another example with a different grid (i.e. Grid 3), and further shows an example of a request to acquire pictures within a set time limit. In FIG. 8B, 831 shows that the category for the target expressions is “Angry.” Under the category “Angry,” four quadrants 855, 857, 859 and 861 showing four target expressions, Disappointed 863, Furious 865, Angry 867 and Deadly 869. In FIG. 8C, a prompt is displayed to show the request 853 with a time limit of 3 minutes, and the time starts running In one embodiment, if a picture that matches one of the four target expressions Disappointed 863, Furious 865, Angry 867 and Deadly 869 is acquired within the time limit, then Grid 3 is unlocked and is considered completed, even if not all four of the target expressions is acquired. Moreover, when the grid is unlocked, rewards may be given to the user. Various forms of rewards have been discussed previously. In another embodiment, the number of target expressions required to unlock the grid may be set. For example, if the number of target expressions required is set to two, then at least two images corresponding to at least two of the target expressions need to be acquired to unlock the grid. In another embodiment, a minimum similarity score may be set such that the acquired picture will not be considered as an adequate match if the similarity score between the acquired picture and any of the four target expressions is less than the minimum similarity score.

The processes described herein for recognizing an acquired image for matching against a target expression may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

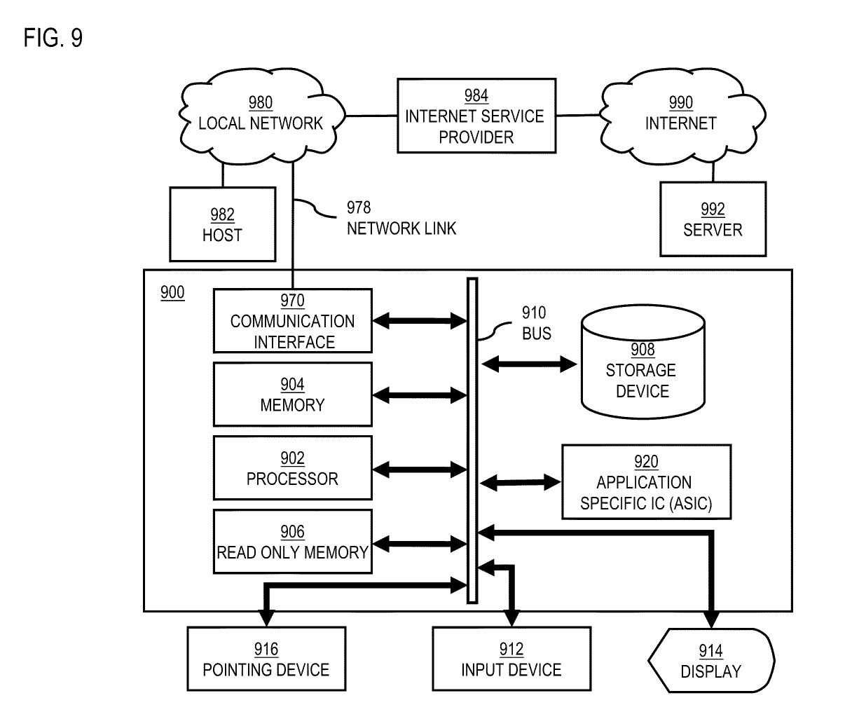

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to recognize an acquired image for matching against a target expression as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of recognizing an acquired image for matching against a target expression.

A bus 910 includes one or more parallel conductors of information so that information is transferred quickly among devices coupled to the bus 910. One or more processors 902 for processing information are coupled with the bus 910.

A processor 902 performs a set of operations on information as specified by computer program code related to recognize an acquired image for matching against a target expression. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or other dynamic storage device, stores information including processor instructions for recognizing an acquired image for matching against a target expression. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for recognizing an acquired image for matching against a target expression, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for recognizing an acquired image for matching against a target expression.

The term “computer-readable medium” as used herein to refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set 1000 upon which an embodiment of the invention may be implemented. Chip set 1000 is programmed to recognize an acquired image for matching against a target expression as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1000, or a portion thereof, constitutes a means for performing one or more steps of recognizing an acquired image for matching against a target expression.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to recognize acquired media for matching against a target expression. The memory 1005 also stores the data associated with or generated by the execution of the inventive steps.

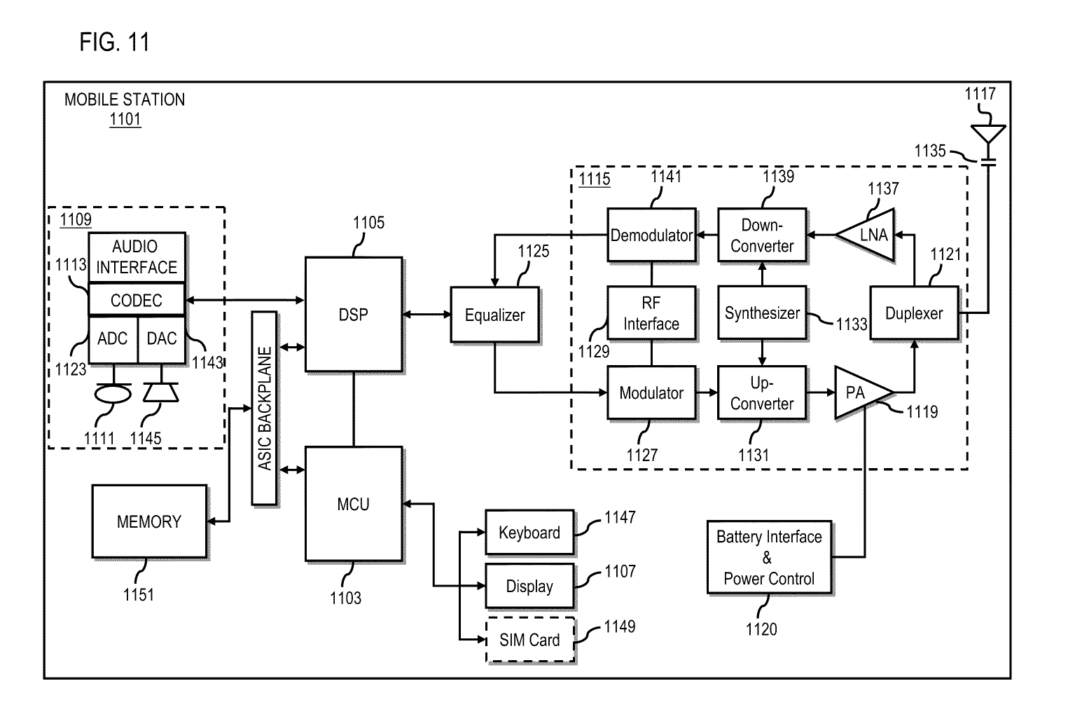

FIG. 11 is a diagram of exemplary components of a mobile terminal (e.g., handset) for communications, which is capable of operating in the system of FIG. 1, according to one embodiment. In some embodiments, mobile terminal 1100, or a portion thereof, constitutes a means for performing one or more steps of recognizing an acquired image for matching against a target expression. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of recognizing an acquired image for matching against a target expression. The display 11 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103—which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to recognize an acquired image for matching against a target expression. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving a request specifying one or more target expressions;
causing, at least in part, acquisition of media including an expression of one or more emotions;
performing recognition analysis on the media to extract expression data;
matching the extracted expression data against reference data corresponding to the one or more target expressions; and
computing a similarity score between the extracted expression data and the matched target expression.

2. A method of claim 1, wherein the request specifies context information for acquiring the media, further comprising:
determining extent of the context information included in the media;
computing the similarity score based further on the determination.

3. A method of claim 1, further comprising:
receiving a request for specifying a time limit for acquiring the media; and
determining whether the media was acquired within the time limit.

4. A method of claim 1, further comprising:
causing, at least in part, capturing of additional media immediately before or after the acquisition of the media;
performing recognition analysis on the additional media to extract additional expression data; and
matching the additional expression data against the reference data of the matched target expression to verify the matching of the extracted expression data.

5. A method of claim 1, wherein the one or more emotions include fear, anger, surprise, contempt, disgust, happiness, and sadness, and wherein the expression includes a facial expression, a body expression, or a combination thereof.

6. A method of claim 1:
receiving an input for selecting the one or more target expressions,
wherein the matching of the extracted expression data is against the selected one or more target expressions.

7. A method of claim 1, further comprising:
causing, at least in part, sharing of the acquired media, the extracted expression data, the one or more target expressions, the matched target expression, or a combination thereof.

8. A method of claim 1, wherein the reference data is collected by crowdsourcing.

9. An apparatus comprising:
at least one processor; and
at least one memory including computer program code,
the at least one memory and the computer program code configured to, with the at least one processor, cause the apparatus to perform at least the following,
receive a request specifying one or more target expressions;
acquire media including an expression of one or more emotions;
perform recognition analysis on the media to extract expression data;
match the extracted expression data against reference data corresponding to the one or more target expressions; and
compute a similarity score between the extracted expression data and the matched target expression.

10. An apparatus of claim 9, wherein the request specifies context information for acquiring the media, and wherein the apparatus is further caused, at least in part, to:
determine extent of the context information included in the media;
compute the similarity score based further on the determination.

11. An apparatus of claim 9, wherein the apparatus is further caused, at least in part, to:
receive a request for specifying a time limit for acquiring the media; and
determine whether the media was acquired within the time limit.

12. An apparatus of claim 9, wherein the apparatus is further caused, at least in part, to:
capture additional media immediately before or after the acquisition of the media;
perform recognition analysis on the additional media to extract additional expression data; and
match the additional expression data against the reference data of the matched target expression to verify the matching of the extracted expression data.

13. An apparatus of claim 9, wherein the one or more emotions include fear, anger, surprise, contempt, disgust, happiness, and sadness, and wherein the expression includes a facial expression, a body expression, or a combination thereof.

14. An apparatus of claim 9, wherein the apparatus is further caused, at least in part, to:
receive an input for selecting the one or more target expressions,
wherein the matching of the extracted expression data is against the selected one or more target expressions.

15. An apparatus of claim 9, wherein the apparatus is further caused, at least in part, to:
share the acquired media, the extracted expression data, the one or more target expression, the matched target expression, or a combination thereof.

16. An apparatus of claim 9, wherein the reference data is collected by crowdsourcing.

17. An apparatus of claim 9, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

18. A computer-readable storage medium carrying one or more sequences of one or more instructions which, when executed by one or more processors, cause an apparatus to at least perform the following steps:
receiving a request specifying one or more target expressions;
causing, at least in part, acquisition of media including an expression of one or more emotions;
performing recognition analysis on the media to extract expression data;
matching the extracted expression data against reference data corresponding to the one or more target expressions; and
computing a similarity score between the extracted expression data and the matched target expression.

19. A computer-readable storage medium of claim 18, wherein the request specifies context information for acquiring the media, and wherein the apparatus is caused, at least in part, to further perform:
determining extent of the context information included in the media;
computing the similarity score based further on the determination.

20. A computer-readable storage medium of claim 18, wherein the apparatus is caused, at least in part, to further perform:
causing, at least in part, capturing of additional media immediately before or after the acquisition of the media;
performing recognition analysis on the additional media to extract additional expression data; and
matching the additional expression data against the reference data of the matched target expression to verify the matching of the extracted expression data.
